(19) United States
(12) Patent Application Publication
(10) Pub. No.: US 2011/0016649 A1
(43) Pub. Date: Jan. 27, 2011

(54) METHOD AND APPARATUS FOR CLEANING THE BARREL OF A FIREARM

(76) Inventors: Paul P. Reggio, Flint, MI (US); James F. Reggio, Flower Mound, TX (US); Eric Scheenherr, Holly, MI (US)

Correspondence Address: THE WEINTRAUB GROUP, P.L.C., 28580 Orchard Lake Road, Suite 140, Farmington Hills, MI, 48334, US

(21) Appl. No.: 12/841,576

(22) Filed: Jul. 22, 2010

Related U.S. Application Data
(60) Provisional application No. 61/227,852, filed on Jul. 23, 2009.

(51) Int. Cl. B08B 9/00

(52) U.S. Cl. 15/104.16

(57) ABSTRACT

An apparatus for cleaning the longitudinal bore of a firearm includes an elongated pull cord which is partially disclosed within a cord cleaning head. A pull weight is attached to the pull cord and has a cross section less than the cross section of the bore of the firearm. The pull weight is dropped into one end of the barrel and is grasped and pulls the cleaning head through the bore. An engagement member has one end of the pull cord secured thereto and in proximity to the cleaning head and engages the cleaning head to enable the pulling of the cleaning head through the bore. In another embodiment hereof, the pull cord comprises a heavy cable which enables replacement of the pull weight. According to this embodiment, a heavy metal cable stop has the cable secured thereto at one end thereof. The cable stop is positioned rearwardly of the engagement member. Depending on the configuration of the cable stop and engagement member, the cable stop may be positionable completely or partially within the engagement member or not at all. Similarly, depending on the configuration of the engagement it may be either solely in abutment with or completely or partially insertable into the cleaning head. A handle has a free end of the cable attached thereto.

### CROSS REFERENCE TO RELATED APPLICATIONS

This application is a Completion Application of co-pending U.S. Provisional patent application Ser. No. 61,227,852 filed Jul. 23, 2009 for “Method and Apparatus for Cleaning the Barrel of a Firearm”, which is hereby incorporated by reference in its entirety including the drawings.

### BACKGROUND OF THE INVENTION

1. Field of the Invention

This invention relates to a method and apparatus for cleaning the bore and breach of a firearm barrel, which apparatus and method is efficient, convenient, easy to use, adapted to interfit the bores of standard firearms but having different bore diameters, and enables a shooter to clean the bore of a firearm on or off the field.

2. Prior Art

In general, deposits of dirt, burnt powder and the like collect on the interior of the barrel of a firearm. Various arrangements for cleaning the dirt from a barrel are disclosed in U.S. Pat. Nos. 4,866,871 to Rivers, issued Sep. 19, 1989; 6,023,873 to Baird, issued Feb. 15, 2000; 6,668,480 to Riley, issued Dec. 30, 2003; and 6,981,345 to Gunn et al, issued Jan. 3, 2006; and U.S. Patent Publications 2005/0188598A1 to Pannanen et al., published Sep. 1, 2005; 2007/0261288A1 to Perry, published Nov. 15, 2007; and 2007/0151472A1 to Nafziger, published Jul. 5, 2007.

These references are identified herein in recognition of a duty of disclosure of known related subject matter, which may be relevant to patentability under 37 CFR 1.56.

The most commonly used cleaning devices employ a rod, often a telescoping rod or segmented rod, having a gun cleaning swab brush or the like firmly attached to one end. In use, the rod pushes the swab through the barrel of the gun to be cleaned. After the barrel has been cleaned it is often desired that the barrel be coated with a thin layer of oil or other lubricant and or rust inhibitor to prevent corrosion.

It has been recognized that the rod must be centered along and aligned with the central longitudinal axis of the barrel to minimize cleaning damage as the rod traverses the bore. However, although suitable in some applications, the rod limits the transportability of a cleaning system for use by the shooter in the field.

Further, the cleaning head affixed to the rod may center the rod but because weapons typically differ as to bore diameter the weapons for which a rod cleaning system may be used is limited.

The cleaning heads of known cleaning devices become quite dirty after use. It is often difficult for users to assemble/disassemble the rods and cleaning elements without coming into contact with the dirty cleaning element. As a result, shooters often postpone cleaning their firearms until they return home from the field.

Ease of replacement of the cleaning head is desirable to enable the cleaning system suitable to be used regardless if the user is on or off the field.

The best time to clean and/or lubricate the barrel is as soon as possible after using it. Accordingly, cleaning the bore regularly after use is an essential part of good firearm maintenance but may be difficult when used during a shooting episode in remote areas because the cleaning system must be transported with the shooter.

There is an ongoing need for improvements in cleaning systems and apparatus for cleaning firearm and rifle barrels.

A primary object of this invention is the provision of a firearm gun barrel cleaning system that is simple, small in size, compact and easy to transport; uses cleaning heads that are inexpensive, easy to replace when dirtied and which do not damage a bore being cleaned, and is efficient and simple to position for usage.

It is a further object of this invention to provide a bore cleaning system that has associated bore cleaning heads that can be used on a wide variety of different weapons that differ in bore diameter.

### SUMMARY OF THE INVENTION

Briefly according to a first embodiment of the present invention, there is disclosed an improved apparatus or system for cleaning the longitudinally extending bore of a firearm, comprising:

an axially elongated pull cord, said pull cord having opposite forward and rearward end portions and of a length greater than the length of the bore through said firearm,

a cored cleaning head, said cleaning head attached to the pull cord between the opposite end potions thereof and adapted to be pulled longitudinally within and between the opposite ends of the bore, said cored cleaning head having forward and rearward ends and a cross-section complementary to and greater than the cross-section of said bore, wherein the head engaging and removing contaminant as the cleaning head is pulled through the bore,

an engagement member proximate to the rearward end portion of said pull cord for engaging the rearward end of said cleaning head, a pull weight, said pull weight being attached to the forward end of said pull cord and having a cross-section less than the cross-section of said bore, and

wherein said pull weight is adapted to be dropped into one end of the bore and out through the opposite end of said bore and pulled upon to pull the engagement member against the cleaning head and the cleaning head through said bore.

According to this firearm cleaning system, the cleaning head has a central passage extending between the forward and rearward ends, wherein said passage is dimensioned to receive and allow axial sliding movement of the cleaning head relative to the pull cord.

Preferably, the pull cord is comprised of a flexible, lightweight durable nylon and said means for releasably captivating comprises the rearward end portion of the pull cord being threaded through the cored center.

Further, the barrel cleaning system comprises means for releasably captivating the engagement member on the pull cord.

In one aspect of this embodiment, the engagement member is comprised of a rigid material, such as HDPE, and is a frusto-conical shaped nose that is juxtaposed with the rearward end face of the cleaning head and adapted to be driven into the opening of the central passage by the pull cord being pulled by the pull weight. The engagement member is contoured to be self-centering with the central passage and operates, in part, to force the outer surface of the engagement member radially outwardly and into firm cleaning engagement with the bore surface to be cleaned. Other embodiments of the engagement member comprise cylindrical members or the like. Depending on the size of the barrel, the engagement can abut the cleaning head; partially extend thereto or can be inserted all the way.

Preferably, the cleaning head is comprised of a resiliently deformable material, such as polystyrene, and the outer surface of the cleaning head is, generally, cylindrical or rectangular and adapted to be compressed and reduced in diameter by longitudinal sliding engagement against the bore of the firewarm barrel. Other geometric configurations may be used including spherical, triangular and the like.

In some applications, the outer surface of the cleaning head may be frusto-conical to enhance centering and cleaning engagement of the cleaning head with bores of different diameter.

Further, in some applications the rearward end of the cleaning head includes a central cavity having a shape complementary to the frusto-conical shaped nose or other configured engagement member, axial pulling of the member into the cavity urging the outer surface of the cleaning head radially outwardly and into cleaning engagement with the bore wall as the pull weight pulls the cleaning head through the barrel.

Further and according to the first embodiment hereof there is disclosed an improved method for cleaning the longitudinally extending bore of a firearm barrel, comprising:

providing a bore cleaning apparatus, the apparatus including an elongated pull cord having first and second ends, a cleaning head attached to the pull cord between the ends thereof, a pull weight attached to the first end, an engagement member attached to the pull cord proximate to the second end thereof, wherein the cross-sections of the pull weight and the cleaning head, respectively, are less than the cross-section of the bore to be cleaned and the pull cord is longer in length than the longitudinal length of the bore,

inserting the pull weight into one end of the bore and permitting the pull weight to fall downwardly through the bore thereof and outwardly of the other end of the barrel, and

pulling on the pull weight by a sufficient amount to draw the engagement member into engagement with the cleaning head and progressively pull the engaged cleaning head through the bore and outwardly of the other end of the barrel.

According to this method, the step of providing includes forming the second end portion of the pull cord into an enlarged knot to captivate the engagement member on the pull cord.

The step of pulling comprises the knot being pulled into contact with the engagement member, with further pulling of the pull cord by the pull weight forcing the cleaning head through the barrel. In other embodiments the knot is replaced with a cable stop.

In another embodiment hereof, the pull cord comprises a rigid heavy cable which enables replacement of the pull weight. According to this embodiment, a heavy metal cable stop has the cable secured thereto at one thereof. The cable stop is positioned rearwardly of the engagement member. Depending on the configuration of the cable stop and engagement member, the cable stop may be positionable completely or partially within the engagement member or not at all. Similarly, depending on the configuration of the engagement it may be either solely in abutment with or completely or partially insertable into the cleaning head.

In an aspect of the second embodiment, the engagement member is substantially cylindrical and includes at least one flange disposed thereabout, the flange contacting the interior sidewall of the barrel and positioning the cable stop.

In a further embodiment hereof an abrasive element or washer is in contact with the forward end of the engagement member and prevents the engagement member from penetrating the cleaning head.

A handle may be used in conjunction with the rigid cable. After the cable is passed through the barrel, its free end is attached to the handle by threading it through suitable apertures or by any other convenient means thereof, after being inserted through the barrel

In other applications, the cleaning head is slit longitudinally from end-to-end and radially inwardly from the outer surface to the center passage, the slit allowing the pull cord or cable to be inserted radially inwardly and into engagement with the cleaning head.

Regardless of the embodiment, the cleaning head may comprise a two part integrally formed substantially cylindrical element having a first open-celled roughened surface for “scraping” the interior wall of the barrel and a smooth second portion that attracts and cleans out the scraped debris. The cleaning head has a central opening through which the pull cord or cable is threaded. Preferably, this embodiment of the cleaning head is formed from polystyrene, polyester polyurethane or similar polymeric material.

It should be noted that the cleaning heads can be also be pushed through the barrel with a telescoping or segmented rod buy the shooter.

The foregoing and other features and advantages of the invention will be apparent to those of ordinary skill in the art from the following more particular description of the invention and the accompanying drawings.

### BRIEF DESCRIPTION OF THE DRAWINGS

The invention will hereinafter be described in conjunction with the appended drawings wherein like designations denote like elements, and in which:

FIG. 1 is a perspective view of an embodiment of an apparatus or system for cleaning the bore of a firearm, according to this invention;

FIG. 2 is a view taken along line 2-2 of FIG. 1 showing a cleaning head, and an engagement member positioned on a pull cord, according to this invention;

FIGS. 3A, 3B, and 3C are perspective views showing the progressive cleaning of a bore of a firearm barrel using the cleaning device of FIG. 1, according to this invention;

FIG. 4 is a cutaway view of FIG. 3C illustrating the pull cord pulling the engagement member into engagement with the cleaning head and the cleaning head cleaning the bore of the firearm barrel;

FIGS. 5A and 5B are perspective and end views showing a second preferred embodiment of a cleaning head according to this invention;

FIG. 6 is a side elevation view in section of a third preferred embodiment of a cleaning head according to this invention;

FIG. 7 is a side elevation view of another preferred embodiment of a cleaning head and engagement member;

FIG. 8 is a perspective view of a further alternate embodiment of the cleaning head hereof;

FIG. 9 is a perspective view of an engagement member and a cable stop used herein of a second embodiment hereof;

FIG. 10 is a perspective view of a still further alternate configuration of the engagement member and cable stop of the second embodiment hereof;

FIG. 11 is a partially exploded perspective view of a still further configuration of the engagement member used in the second embodiment;

FIG. 12 is an exploded view of a still further configuration of the engagement member and cable plug used in the second embodiment herein;

FIG. 13 is another configuration of the engagement member, cable stop and which employs a washer used in the practice of the present inventions;

FIG. 14 is yet another configuration of the engagement member, cable stop and washer used herein;

FIG. 15 illustrates a further configuration for the engagement member and cable stop used herein, and

FIG. 16 is a perspective view of a handle used in the practice of the second embodiment hereof.

### DETAILED DESCRIPTION OF THE INVENTION

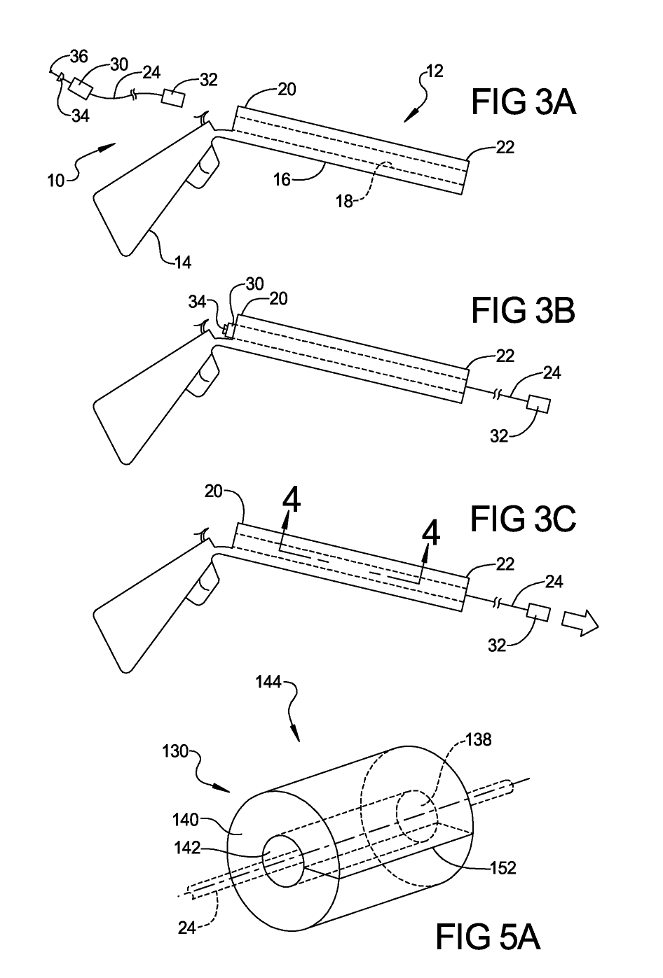

Referring to the accompanying drawing in which like numerals refer to like parts and initially to FIGS. 3A, 3B, and 3C, a first embodiment of a bore cleaning device, system, or apparatus, useful with firearms and wide range of possible bore diameters, is designated generally at 10 for cleaning firearm 12. The firearm 12 is conventional and includes a stock 14 and a barrel 16 having a longitudinally elongated interior bore 18 that extends between the opposite loading and discharge ends 20 and 22, respectively, of the barrel. For loading, the barrel 16 and stock 14 are disengaged, in a conventional manner, and at an acute angle to one another. As will be discussed in detail herein below, as shown, the firearm 12 is positioned in the “loading” position, i.e. the discharge end 22 of the barrel 16 is pointed downwardly, and the cleaning device 10 is positioned for entry into the loading end 20 to be pulled between the ends 20 and 22 of the bore 18.

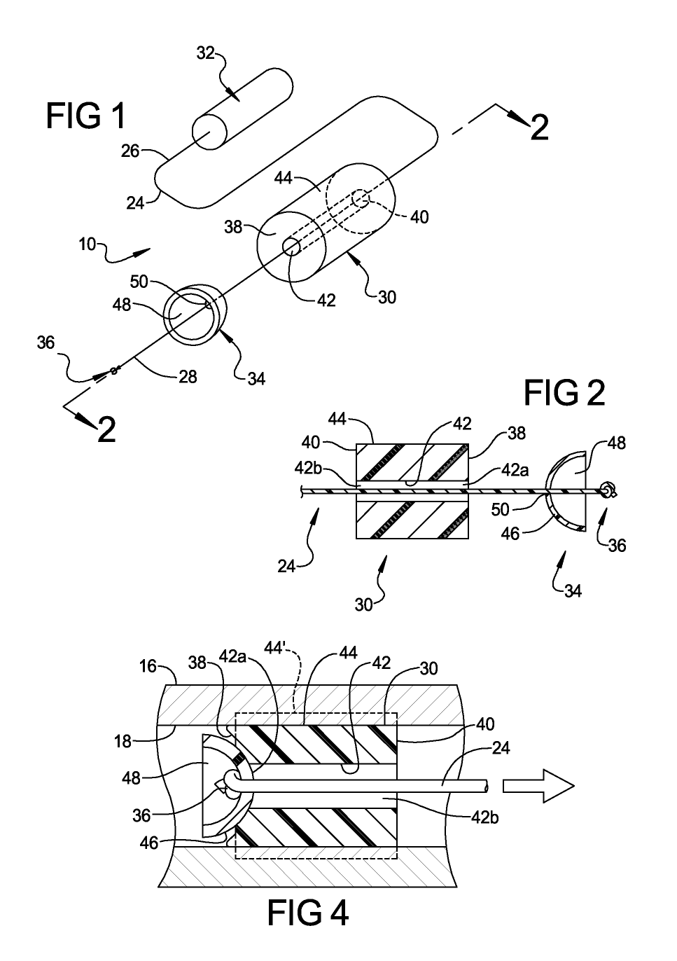

Referring to FIG. 1, the bore cleaning device 10 includes an elongated pull cord 24 having forward and rearward end portions 26 and 28, a cored cleaning head 30 attached to the pull cord, a pull weight 32 fixedly attached to the forward end portion 26 of the pull cord 24, an engagement member 34 attached to the pull cord and disposed between the cleaning head and the second end portion 28 of the pull cord, and an enlarged knot member 36, formed by the second end portion. The pull cord 24 is longitudinally elongated, thin, flexible, lightweight, and greater in length than the longitudinal length of the bore 18. Preferably, the pull cord is comprised of a durable material, such as nylon.

The pull weight 32 is generally cylindrical, complementary in cross-section to that of the bore and has a diameter less than that of the bore. The shape of the weight may be other than cylindrical, such as spherical, and may be comprised of a heavy metal, such as lead or other suitable material.

The cleaning head 30 shown is formed as a hollow cylindrical tube or sleeve having opposite first and second end faces 38 and 40, a cylindrical central passage 42, and a cylindrical outer surface 44. The passage 42 is generally cylindrical and adapted to fit the pull cord 24. The passage 42 and the outer surface 44 are generally coaxial with one another and a central geometric axis and extend between the end faces 38 and 40. The end faces 38 and 40 are generally perpendicular to the geometric axis and the opposite ends 42a and 42b of the passage 42 open on one and the other end face 38 and 40 of the cleaning head 30.

The outer surface 44 is defined by a diameter that is greater than the internal diameter of the bore 18 and is adapted to engage and clean the wall surface of the bore 18.

The cleaning head 30 is formed of a compressible material that will not scratch or otherwise degradingly wear against the wall surface of the bore 18 and will compress and reduce in diameter as the cleaning head 30 is pulled through the bore 18 Preferably, the cleaning head 30 is comprised of polyethylene.

FIG. 4 illustrates the relationship of the cleaning head 30, both undeformed and before being pulled into the barrel (shown in dotted lines) and following being pulled into the bore 18 and in cleaning engagement with the bore.

The engagement member 34 is generally hemispherical or cup-shaped and includes a forward end portion or nose 46, a rearwardly open receptacle 48, and an opening or hole 50 that extends centrally through the nose and receives and passes the pull cord 24. In use, the nose 46 is centered with the opening 42a on the end face 38 of the cleaning head 30 and driven by the knot member 36 against, at least in part, the end face 38 and into the opening 42a of the central passage 42.

The knot member 36 is formed by the rearward end portion of the pull cord 24 and forms a stop member at the rearward end of the pull cord after it is threaded through the hole 50. The knot member 36 is greater in cross-section than the cross-section of the opening 50 in the engagement member 34 and thus cannot be pulled therethrough but engages the engagement member 34. The knot member 36 provides several functions. First, the knot member is releasable and functions as a stop member that captivates and retains the cleaning head 30 and engagement member 34 on the pull cord and when untied enables a dirtied cleaning head to be replaced, whereupon the pull cord is again formed into a knot. The knot member is received in the receptacle 48 and functions as a drive member that forces the engagement member 34 against the end face 38 of the cleaning head.

Referring, again, to FIGS. 3A-3C, the method of use of the cleaning device 10 is illustrated. In FIG. 3A, the firearm 12 is positioned with the barrel 16 pointing downwardly and the cleaning device 10 is positioned at upwardly disposed load opening 20 of the barrel. In FIG. 3B, the pull weight 32 is dropped into the opening 20 of the barrel 16, passed through the bore 18, and expelled (i.e., falls outwardly) from the downwardly disposed discharge opening 22 of the barrel. The pull weight 32 draws the knot member 34 into the receptacle 48, which forces the engagement member 34 against the cleaning head 30 and the cleaning head into position for entry into the upwardly disposed opening 22. In FIG. 3C, the pull weight 32 is pulled by the shooter in a direction away from the barrel, causing the cleaning head 30 to be substantially simultaneously compressed and pulled through the bore with the outer surface 44 of the cleaning head being resiliently forced outwardly and into cleaning engagement with the inner wall of the bore.

FIG. 4 illustrates the cleaning head 30 being pulled through and cleaning the bore 18 of the barrel 16. The dotted lines at 44′ indicate the cleaning head before entry into the bore 18. The pull cord 24 pulls the knot 36 into the receptacle 48 of the engagement member 34 and the nose 46 into the passage opening 42a of the cleaning head 30. The outer surface 44 of the cleaning head 30 is partially compressed because of the difference in diameters and the driving engagement of the nose portion 46 into the opening 42a and end face 38 of the cleaning head partially deforms a rearward end portion of the cleaning head, proximate to the end face 38, to increase cleaning engagement of the surface 44 with and against the bore wall.

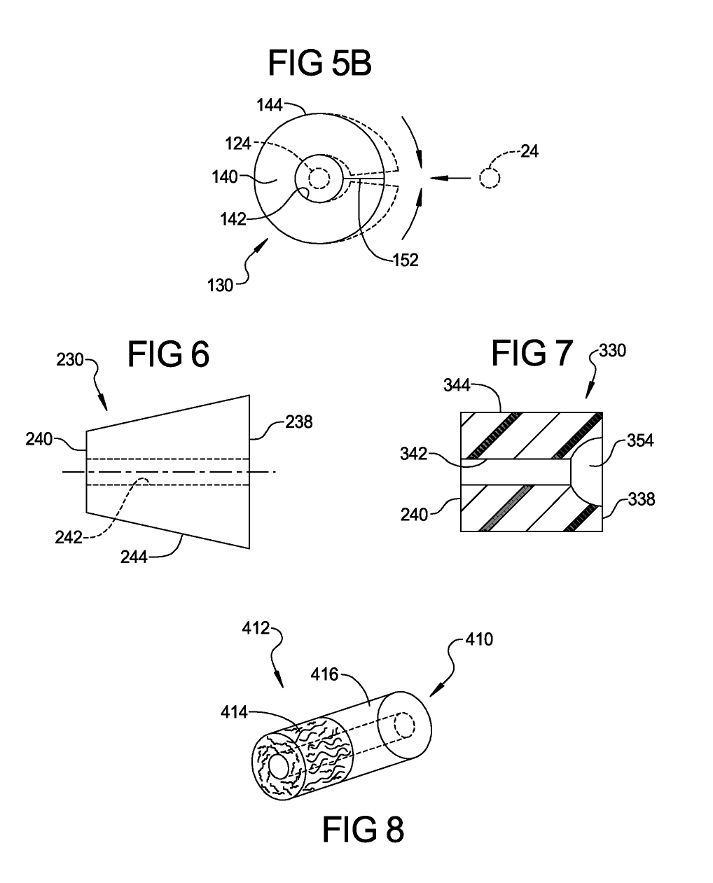

In another preferred cleaning head configuration according to this first embodiment of the invention, referring to FIGS. 5A and 5B, a cylindrical cleaning head 130 is longitudinally slit at 152 from end-to-end 138 and 140 and radially inwardly from the outer surface 144 to a center passage 142. The cleaning head 130 is comprised of materials as described hereinabove for the head 30 and operates to clean the bore 18 in the same manner.

In FIG. 5B, dashed lines illustrate that the longitudinal slit 152 in the cleaning head 130 enables body portions to expand and pass the pull cord 24 to be passed into the center passage 42 and thereby attach the cleaning head 130 to the pull cord. Desirably, the slit enables ease of replacement of a dirtied cleaning head or fitment of a cleaning head having a different diameter or cross-section, depending on the bore to be cleaned.

In another preferred configuration according to this invention, referring to FIG. 6, a cleaning head 230 is formed as a hollow frusto-conical member with forward and rearward ends 238 and 240 and a central passage 242 extending between the ends for receiving the pull cord. The forward end 240 is smaller in diameter than the rearward end 238 and enables centering of the cleaning head 230 with the bore 18 and permits use on bores wherein the diameter is not known exactly. That is, the frusto-conical shaped outer surface 244 ensures that the cleaning head 230 will increase in diameter and function as a one size fits all cleaning head as regards the diameter and bore to be cleaned.

In another preferred configuration for the cleaning head of the first embodiment and according to this invention, referring to FIG. 7, the rearward end face 338 of the cleaning head 330 is provided with a hemispherical receptacle 354, centered on the passage 342. The receptacle 354 has a contour or surface that is complementary with and adapted to receive, seat and center the nose (not shown) of the engagement member, in a manner described hereinabove. Depending on the diameter of the bore, the engagement member will operate to ensure that the cleaning head expands into contact with the bore when the cleaning head 330 is pulled through the barrel.

Referring now to FIG. 8, there is depicted therein a further configuration of a cleaning head in accordance herewith and, generally, denoted at 410. According hereto, the cleaning head is an integrally formed, substantially cylindrical, compressible and expansible, two part or two sectioned body 412 having a first scraping portion 414 and a second smoothing and cleaning portion 416. The scraping portion or section 414 is an open-celled foraminous structure which scrapes the interior wall of the barrel. The second portion 416, being smooth, cleans the barrel of the scraped debris. This cleaning head is an integrally formed molded product formed from any of the materials defined hereinbove and manufactured by methods well-known to the skilled artisan.

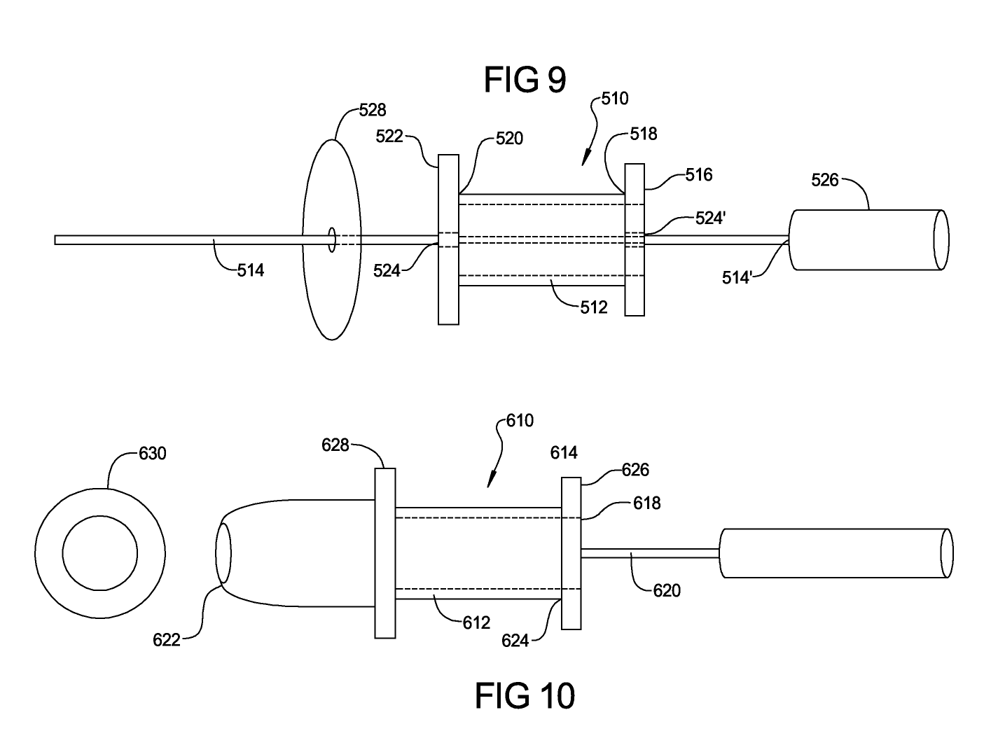

Referring now to FIGS. 9-16 there is depicted therein a second embodiment hereof. According to this embodiment, the pull cord comprises a rigid cable having a free grasping end and a second end secured to a cable stop disposed rearwardly of the engagement member. The cable stop is formed from a heavy metal or other suitable material and is urged into contact with the engagement member by pulling on the free end of the cable. This embodiment eliminates the need for the pull weight as described hereinafter.

Generally, and as shown in FIGS. 9 through 14, the engagement member used herein is a substantially cylindrical member which is adapted and dimensioned at least partially removably insertable, completely insertable or non-insertable into an opening on the rear face of the cleaning head depending on the size of bore and the type of firearm. The engagement member has a central passage through which is past the rigid cable.

The engagement member typically has a length less than that of the cleaning head. The engagement member can be removed from the central passage by pulling on it and separating it and removing it therefrom. This enables removal and disposal of the cleaning head and the changing thereof.

While many materials are suitable, the engagement member 34 is durable, relatively rigid, and capable of withstanding compression loads. Preferably, the engagement member is comprised of a polymer, such as an HDPE, polystyrene, polyester polyurethane or similar plastic. Similarly, the cable stop is, preferably, a heavy object such as a steel cylinder.

Referring again, particularly now to FIGS. 9 through 15 there is depicted therein various alternate configurations for the engagement member and cable stop used in this embodiment.

Referring first to FIG. 9, an engagement member comprises a substantially cylindrical member, generally, denoted at 510. The cylindrical member 510 has a central passage 512 through which a cable 514 is passed. The member 510 has a rearward end 518 and a forward end 520. A first flange 516 is disposed and formed integrally with the member 510 on the rearward end 518.

A second flange 522 is formed at the forward end 520 of the member 510. Each flange has a central opening 524, 524′ to enable the cable 514 to be threaded or passed therethrough a cable stop 514.

The cable 514 has a free end (not shown) and a second end 514. A cable stop 526 is disposed rearwardly of the member 510 and has the second end 514 of the cable secured thereto. The end 514 is secured by any suitable means, such as by crimping or the like.

The cable stop 526 comprises a weighted cylindrical member formed of any suitable material such as steel, lead or the like.

According to this embodiment an abrasive washer 528 is journalled onto the cable 514 proximate the forward end 522 of the member 510. The washer 528 has a central opening 530 slightly larger than the diameter of the cable 514 to enable the washer to frictionally slide thereon and into abutment with the forward end 520 of the member 510.

In use, when the free end of the cable is pulled on, the cable stop 526 is drawn into the interior of the member 510. The washer 528 engages the rearward end or face of the cleaning head (not shown) to prevent the engagement member from penetrating the cleaning head. Rather, the engagement member urges the cleaning head through the barrel of the firearm.

Referring now to FIG. 10, an engagement member 610 comprises a cylindrical member or body 612 having a rearward section 614 and a forward section comprising 616 a “bullet-like” configuration end. As with the other embodiments, a central passage 618 enables a cable 620 to extend therethrough.

As shown, the engagement member 610 has a forward end 622 and a rearward end 624.

A rear flange 626 having a central opening 626 which communicate with the passage 618 is integrally formed with the member 612 and serves to direct the cable stop into the passage 618. A second flange 628 is provided medially of the member 610 and has a larger diameter than that of the rear flange and is dimensioned to engage the barrel wall (not shown).

The forward bullet end 616 of the member 612 cooperates with the medial flange 628 to limit penetration of the member or stem 610 into the cleaning head (not shown).

According to the embodiment, an abrasive washer is also deployed and journalled onto the cable as described above.

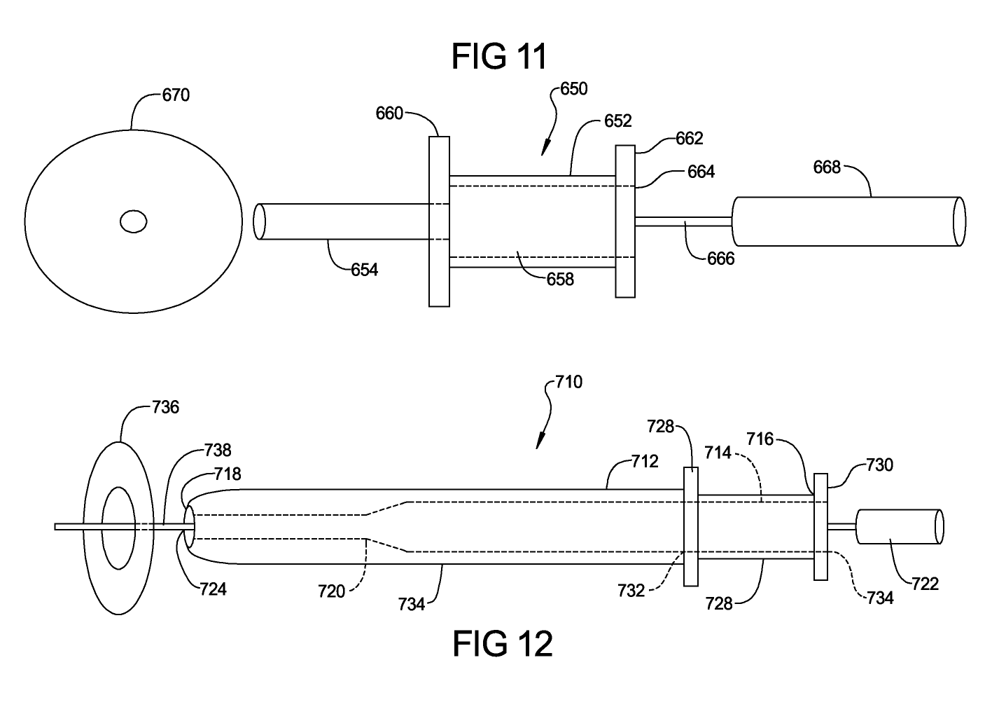

Referring now to FIG. 11 depicted therein is a still yet further configuration of the engagement member used in the second embodiment of the present invention and, generally, denoted at 650. As with the previous embodiments the configuration member comprises a first cylindrical section 652 and a second reduced diameter forward section 654. The forward section 654 has a hollow interior to define a passageway 656 therethrough through which a cable may be passed or strung through as discussed hereinbelow.

The first section 652 similarly has an internal passage 658. The internal passage 658 communicates with, but is larger in diameter than that of the passage 656.

The first section 652 is bounded by a pair of flanges 660, 662, respectively. The flange 662 is a rearward flange and has a central opening 664 sufficient to permit a cable stop 668 to project therethrough. The forward flange 660 has a central opening 661 smaller than that of the passage 658 and does not permit a cable stop 668 to pass therethrough.

As with the other configurations, a cable 666 is secured to the cable stop 668. Likewise, a washer 670 is journalled onto the cable 666 proximate the free end of the reduced diameter section 654 of the engagement member. In use, the cable 668, when pulled upon, enables the cable stop to be inserted only into the first section 652. Because of the reduced diameter in the flange 660 the cable stop cannot go therepast.

Similarly, the flange 660 in, combination with the washer 670, precludes the first or rearward section of the engagement member from penetrating into a cleaning head.

The forward section 654, preferably, is dimensioned to project entirely through a reduced diameter cleaning head (not shown).

In all other respects this embodiment is similar to those previously described.

Referring now to FIG. 12 there is depicted therein a further configuration of an engagement member for use herein and generally denoted at 710. As with the previous embodiments the engagement member comprises a substantially cylindrical member or body 712. The cylindrical member has an internal passage 714. As with the other embodiments the cylindrical member has a rear face 716 and a forward face 718.

The internal passage 714 extends from the rear face 716 through the member, but has a reduced diameter portion formed therewithin as at 720. The reduced diameter portion, as will be detailed below, acts as a stop to limit the movement of a cable stop, shown at 722, within the engagement member while permitting a cable or cord 724 to project clear through.

As shown in FIG. 12, the engagement member 710, comprises a first or rearward section 726 which is bounded by a pair of spaced apart flanges 728 and 730. Each of the flanges has a central opening 732 and 734, respectively, to enable the cable stop 722 to pass therethrough. The body 712 include a second elongated bullet-like section 732 forward of the flange 728. The section 732 has a face 718 terminates at an arcuate tip.

Again, as with the previous embodiments a washer 736 is journalled onto a cable 738 and is disposed in abutment with the end or face 718 of the engagement member. Here, the washer has a diameter sufficient to permit the forward section 732 of the engagement member 712 to be inserted into a cleaning head (not shown), while acting as a barrier in conjunction with the flange 728 to permit the first section 732 only to be inserted into a cleaning head. This embodiment enjoys utility with long cleaning heads.

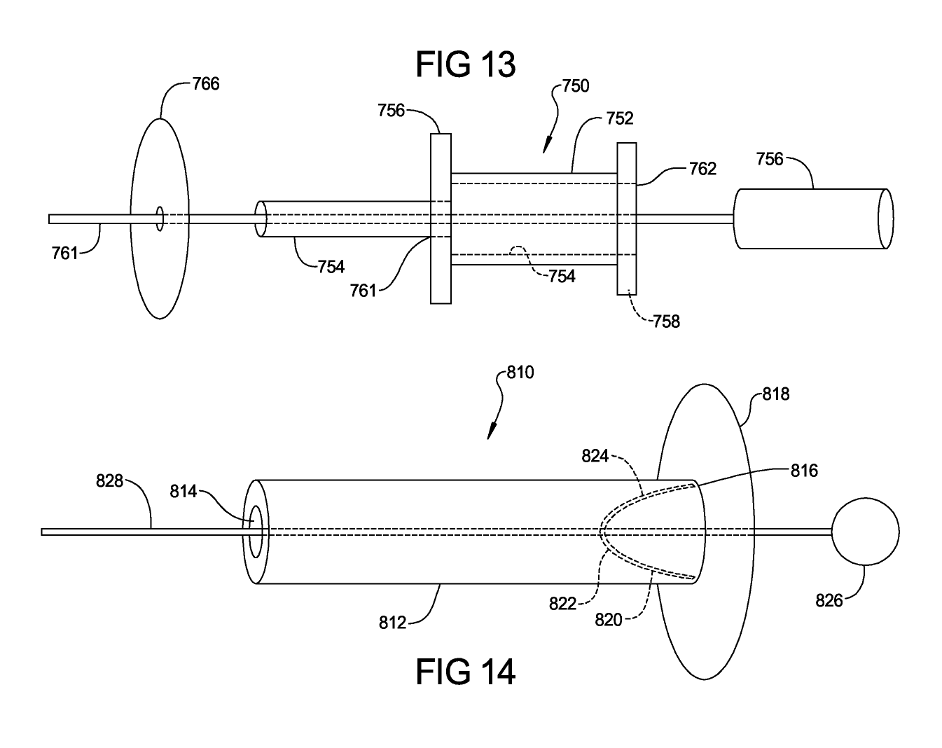

Referring now to FIG. 13 there is still a further embodiment of the engagement member hereof. Here, the embodiment shown, generally, at 750 includes a first section or rearward section 752 and a forward section 754 integrally formed therewith. As shown, the forward section 754 is a reduced diameter portion or section which is substantially cylindrical.

The first or rearward section 752 has an internal passage 754 having a diameter sufficient to permit the insertion of a cable stop 756 thereinto.

As with the embodiment of FIG. 12, the first or rearward section 752 is bounded by a pair of spaced apart flanges 756 and 758. The rearward most flange 758 has a central opening 760 of sufficient diameter to permit the insertion of a cable stop 756 therepast.

The forward most flange 756 has a reduced diameter central opening 760 the diameter of which is small enough to prevent the passage of the cable stop therepast. The opening 760 is coaxial with the hollow interior of the first section 754 to enable a cable 764 to pass therethrough.

As with the other configuration a washer 766 which is, preferably, an abrasive washer, is journalled onto the cable 764 and into abutment with the free end of the first section 754 of the engagement member, as shown.

Referring now to FIG. 14 there is depicted therein a further configuration of an engagement member useful in the practice of the present invention and, generally, denoted at 810. Here the engagement member 810 comprises a substantially cylindrical member or body 812 having an internal passageway 814. The member 812 has a first or free end 814 and a second or rear end 816. A toroidal flange 818 is integrally formed with the cylindrical member at the rear end 816. The flange 818 has a diameter larger than that of the cylindrical member 810 but is small enough to be able to be passed through a barrel of a firearm.

As shown, a seat 820 is formed internally in the cylindrical member 812 proximate the rear end 816. The seat is, preferably, parabolic in shape, as shown.

The parabolic seat as an opening 822 provided at the apex 824 thereof.

A spherical cable stop, generally, denoted at 826 is dimensional to removably seat in the seat 820.

A cable cord 828 is secured to a spherical cable stop 826 and projects through the opening 822 and the passage 814 in a manner similar to that herebefore described.

The seat 822 removably nests or seats the stop 826 as it is pulled thereinto.

The cylindrical member 812 may be dimensioned to either project into a cleaning head or to abut thereagainst, as desired, and depending upon the nature of the firearm barrel to be cleaned.

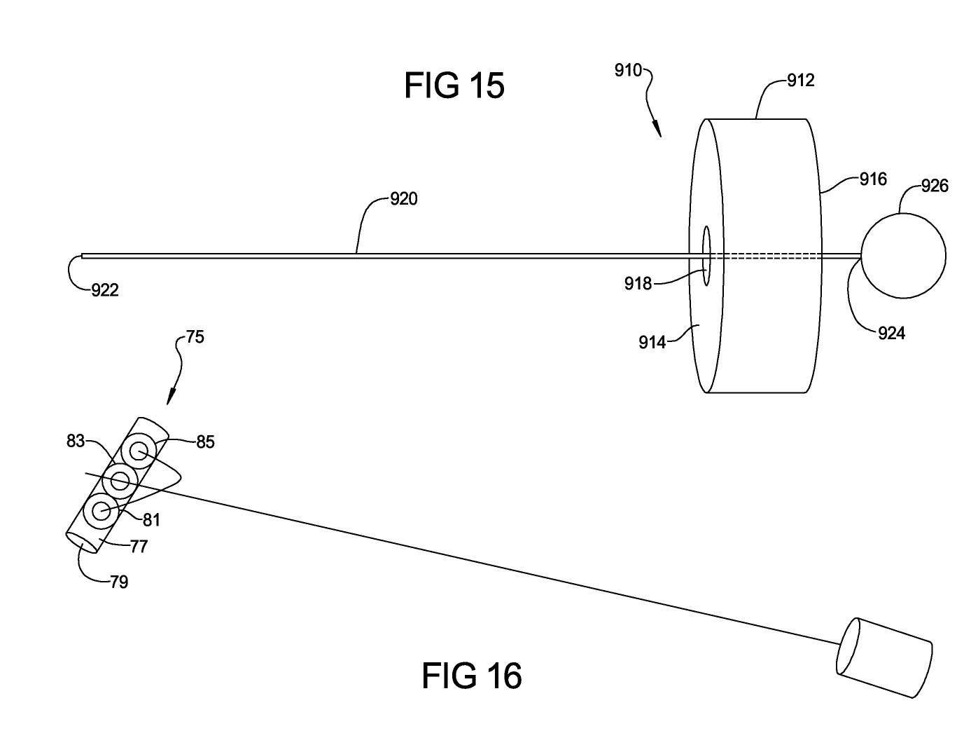

Referring now to FIG. 15 there is depicted a further embodiment of the engagement member, generally, denoted at 910. Herein, the engagement member is a cylindrical member 912 having a first end 914 and a second rearward end 916. The member 912 has a central passage or opening 918. A cable or pull cord 920 has a diameter sufficiently small to enable it to be passed through the opening or passage 918. The cable has a first or free end 922 which is dropped through the barrel as described hereinabove. A second or opposite end 924 is secured to a cable stop 926.

Here, the cable stop 926 is a spherical or elliptical member which has a diameter greater than that of the passage 918.

In use, the engagement member has a diameter greater than that of a cleaning head and, thus, only abuts against the rearward end thereof.

In all other respects this embodiment of the engagement functions as hereinabove described.

In FIG. 16 there is depicted a handle 75 for use in connection with the present cleaning system. The handle 75 is a cylindrical member 77 having a hollow interior 79. A plurality of openings 81, 83 and 85 are formed in the cylindrical member and are in communication and or registry with the interior. Any cable used in the practice of the present invention can be threaded or otherwise laced through the holes and tied off to thereby provide a means for grasping the cable 77.

In use, the cable is dropped through a barrel and its free end is laced through the handle externally of the barrel. Once laced, the handle is then grasped and pulled on to draw a cable stop into contact with an engagement member which, in turn, engages a cleaning head. Continued pulling on the handle causes the assembly of cable stop, engagement member and cleaning head, with or without a washer, to traverse the interior of a barrel to clean and/or lubricate same. The same method is used even without the handle by pulling on the cable.

As can be appreciated herein, the cleaning device according to this invention enables different cleaning heads to be used, the heads being of different cross-sectional shapes, diameters, and materials and possibly provided with lubricating and cleaning oils to clean residue from the barrel without marring or damaging the surface. Replacement can be done in the field and cleaning heads may be replaced to effect different types of treatments.

Although depicted in the drawings with respect to a shotgun, the cleaning device of the invention herein can be extended to the cleaning of the barrels of other firearms and weapons with various sized bores. The soft conformable nature of the cleaning head will ensure that the inner bore will remain unmarred for maximum barrel life and accuracy for both rifled and smooth bore firearms.

Having, thus, described the invention what is claimed is:

1. A system for cleaning the barrel of a firearm comprising:
an axially elongated pull cord, said pull cord having opposite forward and rearward end portions and of a length greater than the length of the bore through said firearm,
a cored cleaning head, said cleaning head having the pull cord passing therethrough adapted to be pulled longitudinally within and between the opposite ends of the bore, said cored cleaning head having forward and rearward ends and a cross-section complementary to and greater than the cross-section of said bore, wherein the head engaging and removing contaminant as the cleaning head is pulled through the bore,
an engagement member proximate to the rearward end portion of said pull cord for engaging the rearward end of said cleaning head.

2. The system of claim 1 wherein:
said passage is dimensioned to receive and allow axial sliding movement of the cleaning head relative to the pull cord.

3. The system of claim 1 which further comprises:
means for releasably captivating the engagement member on the pull cord, the engagement member comprising a rigid material.

4. The system of claim 3 wherein the engagement member having at least a portion thereof the removably positionable into the opening of the central passage of the head by the pull cord being pulled by the pull weight.

5. The system of claim 1 wherein the pull cord comprises a flexible, lightweight durable nylon and the means for releasably captivating comprises the rearward end portion of the pull cord being threaded through the cored center.

6. The system of claim 1 wherein cleaning head comprises a resiliently deformable material, the cleaning head being compressible and reducible in diameter by longitudinal a sliding engagement against the bore of the firearm barrel.

7. The system of claim 1 wherein the cleaning head is provided with a longitudinal slit permitting the pull cord to be inserted radially inwardly into engagement with the cleaning head.

8. The system of claim 1 wherein the cleaning head includes a central cavity complementary to the shape of the forward end of the engagement member.

9. The system of claim 1 wherein the engagement member comprises:
a substantially cylindrical member having a central bore formed therethrough through which the pull cord is inserted, the engagement member having at least one flange integrally formed an exterior of the mark, the at least one flange having a diameter greater than that of a bore of a firearm, the flange and the cleaning head being compressible to enable the flange to engage the interior side wall of the barrel.

10. The system of claim 9 which comprises:
a first flange disposed at the rearward end of the cylindrical member, and
a second flange disposed medially of the cylindrical member, the second flange limiting insertion of the engagement member into the cleaning head therepast.

11. The system of claim 10 which further comprises:
an abrasive washer surrounding the pull cord and disposed proximate the forward end of the cylindrical member.

12. The system of claim 9 which further comprises a pull cord stop disposed rearwardly of the engagement member, the stop contacting the engagement member to enable tension on the pull cord when pulled.

13. The system of claim 1 which further comprises:
a pull weight, said pull weight being attached to the forward end of said pull cord and having a cross-section less than the cross-section of said bore, and
wherein said pull weight is adapted to be dropped into one end of the bore and out through the opposite end of said bore and pulled upon to pull the engagement member against the cleaning head and the cleaning head through said bore.

14. The system of claim 1 wherein;
the pull cord comprises a cable,
the system further compromising a cable stop, the cord being secured to the stop at one end thereof rearwardly of the engagement member.

15. The system of claim 14 which further comprised;
a handle, the handle having a free end of the cable attached thereto.

16. The system of claim 12 wherein:
the engagement member is configured to at least partially receive the cable stop therewithin and to at least partially penetrate the central passage of the cleaning head.

17. The system of claim 1 wherein:
the engagement member is configured to at least partially receive the cable stop therewithin and to at least partially penetrate the central passage of the cleaning head.

18. The system of claim 1 wherein:
the cleaning head comprises a first section and a second section, the second section being a foraminous scraping portion, and
the first section being a substantially smooth wall section.
